(19) United States
(12) Patent Application Publication
(10) Pub. No.: US 2015/0135937 A1
(43) Pub. Date: May 21, 2015

(54) METHOD TO PRODUCE BALLISTIC AND STAB RESISTANT STRUCTURES FOR GARMENTS AND STRUCTURES PRODUCED BY THE METHOD

(71) Applicant: E I DU PONT DE NEMOURS AND COMPANY, Wilmington, DE (US)

(72) Inventors: Yves Bader, Crozet (FR); Nicolas Pont, St. Juliene en Genevois (FR)

(21) Appl. No.: 14/538,014

(22) Filed: Nov. 11, 2014

Related U.S. Application Data
(60) Provisional application No. 61/905,335, filed on Nov. 18, 2013.

(51) Int. Cl. F41H 5/04; B32B 37/26; D06M 15/227; B32B 5/26; D06M 15/263

(52) U.S. Cl. CPC F41H 5/0478; B32B 5/26; D06M 15/263; D06M 15/227; B32B 37/26; B32B 2250/20; B32B 2260/023; B32B 2260/046; B32B 2305/076; B32B 2307/581; B32B 2307/558; B32B 2571/02; D06M 2101/36
USPC 89/36.02; 442/134; 442/135; 156/247

(57) ABSTRACT

The invention pertains to a composite wherein the composite comprises at least one fabric and a thermoplastic polymeric resin wherein the resin is impregnated into the fabric to an extent that between 80 to 95% of the maximum volumic mass (void volume) of the fabric is filled with resin. The fabric and thermoplastic resin are combined with one or two release layers to form an assembly. A plurality of these assemblies is combined to form a stack which is subjected to thermopressing wherein the thermopressing is carried out in at least two cycles with a pressure release between each cycle.

### BACKGROUND

1. Field of the Invention

The present invention relates to enhanced, flexible light weight energy absorbing materials and methods of making them. These materials have utility in the manufacture of personal protection equipment, such as soft armor, stab, spike and hypodermic needle protection systems.

2. Description of Related Art

Aramid fibers are a class of heat-resistant and strong synthetic fibers that are used in a wide variety of industrial applications. One prominent use of aramid fibers is in ballistic rated body armor fabrics, such as personal protection equipment (PPE), such as bullet-resistant vests.

While the woven aramid fabrics in PPE offer good protection against ballistic threats such as bullets, they are more vulnerable to sharp and thin weapons such as knives and ice picks. This is can be explained by the fact that thin weapons can pass between the fibers making up the fabric, because the fibers are pushed apart by the penetrating point of the weapon. In an effort to improve the protection against knife and spike attacks, protective fabrics are now commonly reinforced with synthetic resins that can be of thermoplastic or thermoset nature, and which restrict relative movement of the fibers in the case of an attack. Thus, the fibers cannot be pushed apart by a thin weapon because they are partially or fully fixed in place by the resin. Such a technology is described in, for example, WO 2001/037691 which discloses a protective material that is more flexible than other known protective materials and where the gain in flexibility is primarily achieved by the low denier count of the fibers used. The fibers are furthermore embedded within a support material to restrict relative movement of the fibers and thus to achieve good protection against knife or needle attacks.

However, when embedding the fibers of a protective material such as for example para-aramid fabrics with polymeric resins, there is always also a rigidification that is caused by the embedding, because the embedding reduces the ability of the fibers to move relative to each other. For example, when an embedded fabric is bent, it will immediately snap back into its initial shape, in contrast to a non-embedded fabric. Therefore, embedded fabrics are stiffer when compared to non-embedded fabrics and concurrently, personal protection equipment (PPE) manufactured from embedded fabrics are perceived as causing more discomfort. This perception leads to a reduced willingness to wear the PPE and therefore needs to be prevented by offering a more supple and/or flexible PPE.

Embedding of the fibers is commonly carried out in known manners, such as for example by lamination, calendaring or heat pressing of thermoplastic or thermoset resin sheets onto the fibers. As the necessary machinery is well known and used by many manufacturers of personal protection equipment (PPE), it is desirable to reduce the modification of the embedding methods to a minimum so that eventual new resins can be applied in the same known fashion.

U.S. Pat. No. 5,866,658 discloses thermoplastic compositions which are blends of ionomers with polyamides. However, the blends are used as molded parts for automotive applications such as bumpers, fender extensions and hub caps, to improve high gloss, toughness and scratch resistance.

U.S. Pat. No. 5,859,137 discloses thermoplastic ionomers based on copolymers of ethylene and carboxylic acids as well as combinations of such ionomers with polyamides. However, such combinations are mainly useful for applications to improve impact resistance and mechanical strength.

PCT publication WO 01/37691 discloses a protective material comprising a plurality of separate flexible layers each layer comprising a plurality of high strength fibers capable of resisting penetration by a knife or sharp-pointed objects such as icepicks and hypodermic needles, and a support material, wherein at least part of the fibers are embedded within the support material to restrict relative movement of the fibers therein. The high-strength fibers are of equal below 600 deniers.

PCT publication WO 03/053676 discloses multiple threat penetration resistant articles. The articles include, fabric layers, polymer impregnated fabric layers and woven fabric layers. The articles can additionally include tightly woven fabric layers which define the strike face of the article.

PCT publication WO 2011/156577 discloses enhanced flexible lightweight ballistic, stab and spike resistant materials which use a thermoplastic composition for manufacturing personal protection equipment, wherein the thermoplastic composition comprises at least a first thermoplastic polymer that has a melting point different to the melting point of a second thermoplastic polymer.

PCT publication WO 2010/036406 discloses a method for producing fiber composites impregnated with a thermoplastic resin to be used as stab and ballistic composite structures.

PCT publication WO2008/105929 relates to adhesive compositions used in composite laminar structures to improve ballistic resistance, for example, which limits the penetration of a bullet from a gun. The composite laminar structures includes composite laminar structure, includes an aramid or olefin fiber layer, a eutectic impact absorbing adhesive resin or adhesive composition layer, and an ionomer layer. The aramid or olefin fiber layer is adhesively bonded with the eutectic impact absorbing adhesive resin or adhesive composition layer to the ionomer layer. In further embodiments, the composite laminar structure includes an olefin fiber layer, a eutectic amorphous acid functional polypropylene copolymer adhesive layer, and an ionomer layer. The olefin fiber layer is adhesively bonded with the eutectic amorphous acid functional polypropylene copolymer adhesive layer to the ionomer layer. The olefin fiber layer has no polarity within a matrix thereof and has no affinity for moisture.

PCT publication WO2006/069950 relates to a heat-shrinkable multilayered film comprising at least one carrier layer a) based on at least one thermoplastic polymer, at least one gas barrier layer, and at least one sealing layer. The entire free surface of the carrier layer opposing the gas barrier layer is covered with an outer release layer having a plasticizing or melting temperature that is at least 30° C. higher than the sealing or melting temperature of the sealing layer.

U.S. Pat. No. 6,645,336 to Albertone describes a process for the preparation of a laminate, particularly a waterproof moisture vapor permeable laminate, comprising a substrate having on a surface thereof a thermoplastic polymer resin coating and further comprising a peelable release layer in contact with the surface of the thermoplastic polymer resin remote from the substrate, and optionally further comprising a tie layer between the substrate and the thermoplastic polymer resin, the process comprising the steps of forming or providing a substrate layer and providing on a surface thereof a thermoplastic polymer resin coating and a peelable release layer and optionally providing a tie layer between the substrate and the thermoplastic polymer resin coating, characterized in that the thermoplastic polymer resin has a viscosity less than about 3000 Pa·s measured according to the standard IS011443.

PCT publication WO 2002/26463 discloses an efficient method of simultaneously molding multiple composite laminates comprising layering one or more layers of wet-laid, non-woven mats comprised of particulate thermoplastic polymer and a fiber reinforcement between one or more layers of a release film material and molding the combination to form multiple laminates.

With the aim of further improving stab and ballistic resistance of protective articles, composite structures based on resins and aramid fabrics have been developed such as WO 2001/037691 cited above. It discloses a protective material comprising a plurality of separate flexible layers, each layer comprising a plurality of high-strength fibers and a support material made of a resin. By being embedded within the resin, the relative movement of the fibers upon an impact caused to the wearer is reduced thus leading to an increased blunt trauma resistance.

Conventional processes used to manufacture such composite materials involve first a lamination step and then a resin melting step. The lamination step comprises the extrusion of the resin into a film, which film is then laminated onto the fabric made of high-strength fibers in order to have a sufficient adhesion between the film and the fabric and to form a composite assembly. This process requires the use of a release layer which is typically made of silicone paper and which is positioned between the film and the laminating rolls to prevent the so-manufactured composite assembly from sticking to the heated rolls. The use of these release layers requires manufacturing machines with three or more rolls depending on whether the fabric is impregnated on one side or both sides. This implies more complex tensioning systems and operating procedures and lowers the overall manufacturing speed.

In the resin flowing step, the composite assembly obtained under the lamination step undergoes heat and pressure in a heating press (thermopressing) in order to allow the resin to flow through the fabric and, therefore, to at least partially impregnate it. The resin impregnation improves the protective effect of the final composite structure. The flowing step is typically a batch process where sheets of composite assembly manufactured under the lamination step are pressed together.

In order to increase the production yield under the resin flowing step, it is known to load the heating press with as many layers as possible of the composite assembly obtained under the lamination step. In such a case it is however essential to interpose a release layer like that described above between each of two composite assembly layers in order to prevent them from fusing together during thermopressing. The preparation of this multilayer stack is made by a conventional machine which alternatively deposits release layers and composite assemblies, and optionally cuts the borders of the stack to match the size of the heating press. After pressing and cooling the stack, the release layers between each so impregnated composite structure must be eventually removed.

The use of release layers during the lamination step and the resin flowing step increases the complexity and costs of the overall manufacturing process. Moreover, the release material described above is expensive and cannot be used for more than a production cycle and it is usually difficult to dispose of, particularly if made of silicone paper. An increase of energy consumption associated with the thickness of the silicone paper further strengthens the environmental concerns.

There is however a need to further reduce the rigidity of embedded fabrics for example as disclosed in WO 2011/156577, while at the same time offering comparable protection against multiple threats such as knife, stab and needle attacks and also at the same time provide a solution that can be executed on pre-existing machinery in an efficient production process with an improved productivity as a new and inventive improvement over the method disclosed in WO 2010/036406.

### SUMMARY OF THE INVENTION

This invention pertains to a method of producing composite comprising the steps of:
(a) providing an assembly comprising in order, a release layer, a thermoplastic resin layer, a fabric and, optionally, a second release layer,
(b) combining a plurality of assemblies of step (a) into a stack,
(c) Subjecting the stack from step (b) to a thermopressing process wherein the process comprises a minimum of two cycles where each cycle comprises
   (i) thermopressing the stack for a defined period under a defined temperature and pressure, and
   (ii) releasing the pressure on the stack for a defined period of time,
(d) cooling the stack,
(e) removing the individual assemblies from the stack, and
(f) removing the release layer(s) from each assembly to leave a composite,
   wherein the defined time periods, temperatures and pressures of each thermopressing cycle are such that the composite has between 80 to 95% of the void volume of the fabric filled with resin.

The invention further pertains to a ballistic, knife and pick resistant article comprising a plurality of composites made by the above method wherein the composite comprises at least one fabric and a thermoplastic polymeric resin wherein the resin is impregnated into the fabric to an extent that between 80 to 95% of the maximum volumic mass (void volume) of the fabric is filled with resin.

### BRIEF DESCRIPTION OF THE DRAWINGS

FIG. 1 shows one example of a thermopressing cycle.

### DETAILED DESCRIPTION

The present invention solves the problems stated in the background section by providing a fabric-thermoplastic resin composite for the use in personal protection equipment (PPE), wherein the thermoplastic composition is embedded in the fiber in order to form non-continuous continuum with the fibers and across the fibrous layer section. The term melting point as used in this description is intended to mean the temperature determined by means of DSC (Differential Scanning calorimetry) at heating rates of 10 degrees C. per minute, according to DIN 53765-8-10. The term non-continuous continuum with the fibers as used in this description refers to an interrupted three-dimensional matrix where some places are not restricted for relative movement of the fibers with the polymer matrix.

### Composite

The composite of this invention comprises at least one fabric and a thermoplastic polymeric resin wherein the resin is impregnated into the fabric to an extent between 80 to 95% of the maximal volumic mass. The maximal volumic mass corresponds to a total impregnation of the fabric with the polymer. Maximal volumic mass can be defined by the density obtained after pressing the fabric with the polymer at a temperature of about 60° C. above the polymer melting temperature and at a pressure of 20 bars for 30 minutes.

Voids are any free spaces in the fiber resin matrix that are not fiber or resin. If the void volume of fabric is filled with resin to an extend such as the volumic mass is greater than 95% of the maximal volumic mass then the resulting composite is too stiff and will not have a bending stiffness lower than 300 mNm. If the void volume of fabric is insufficiently filled with resin, that is, to an amount of less than 80% of the maximal volumic mass, then the ability of an article comprising a plurality of composites to prevent knife or spike penetration is compromised.

### Thermoplastic Resin

The thermoplastic polymer according to the present invention may be polyvinyl, polyolefin and/or polycondensates such as polyethylene, polyethylene copolymers, polypropylene, polypropylene copolymers, polybutylene, polybutylene copolymers, polyamides, polyamide copolymers, polyesters, polyurethanes, polyurethane copolymers, polyacrylonitriles, polysulfones, thermoplastic silicone copolymers, thermoplastic elastomeric block copolymers, such as acrylonitrile-butadiene-styrene, polyisopropene-polyethylene-butylenepolystyrene or polystyrene-polyisoprene-polystyrene block copolymers, polyether-ester block copolymers, and/or combinations thereof. Preferably, the thermoplastic polymer is chosen among those mentioned polymers having a melting point in the range of from 60° C. to 250° C. and more preferably from 60° C. to 150° C.

Preferably, the thermoplastic polymer according to the present invention can be chosen among polymers, for example, thermoplastic elastomeric block copolymers, like for example, but not limited to, polyisopropene-polyethylene-butylene-polystyrene or polystyrene-polyisoprene-polystyrene block copolymers, or, for example, polyolefins, like for example, but not limited to, polyethylenes, for example, low density polyethylenes, very low density polyethylenes, metallocene polyethylenes and/or polyethylene copolymers, for example, ethylene/α,β-unsaturated C3-C8 carboxylic acid copolymers and/or ethylene/α,β-unsaturated C3-C8 carboxylic acid copolymers partially neutralized with metal salts.

More preferably, the thermoplastic polymer according to the present invention can be chosen among polyethylene copolymers, for example, ethylene/α,β-unsaturated C3-C8 carboxylic acid copolymers and/or ethylene/α,β-unsaturated C3-C8 carboxylic acid copolymers partially neutralized with metal salts.

In the case where the thermoplastic polymer is an ethylene/α,β-unsaturated C3-C8 carboxylic acid copolymer, the α,β unsaturated C3-C8 carboxylic acid can be chosen from acrylic acid and/or methacrylic acid.

The ethylene/α,β-unsaturated C3-C8 carboxylic acid copolymer is preferably a terpolymer of ethylene, α,β-unsaturated C3-C8 carboxylic acid and α,β-unsaturated C3-C8 dicarboxylic acid.

The α,β-unsaturated C3-C8 dicarboxylic acid can be chosen from maleic acid, maleic anhydride, C1-C4 alkyl half esters of maleic acid, fumaric acid, itaconic acid and itaconic anhydride.

Preferably, the α,β unsaturated C3-C8 dicarboxylic acid can be chosen from maleic anhydride, ethyl hydrogen maleate and methyl hydrogen maleate.

Most preferably, the α,β-unsaturated C3-C8 dicarboxylic acid is maleic anhydride, methyl hydrogen maleate and/or combinations thereof.

The ethylene/α,β-unsaturated C3-C8 carboxylic acid/α,β-unsaturated C3-C8 dicarboxylic acid polymer can further comprise up to 40 weight percent of an C1-C8 alkyl acrylate softening comonomer, which is preferably chosen among methyl(meth)acrylate, ethyl(meth)acrylate or n-butyl(meth)acrylate, more preferably from n-butyl acrylate or ethyl(meth)acrylate.

The term softening comonomer as mentioned in this description is well-known to those skilled in the art and refers to comonomers such as the C1-C8 alkyl acrylate mentioned above.

The term (meth)acrylate as mentioned in this description is respectively intended to mean acrylate and methacrylate.

In the ethylene/α,β-unsaturated C3-C8 carboxylic acid/α,β-unsaturated C3-C8 dicarboxylic acid polymer, the α,β-unsaturated C3-C8 carboxylic acid can be present in a range of 2 to 25 weight percent and the α,β-unsaturated C3-C8 dicarboxylic acid can be present in a range of 0.1 to 15 weight percent with the proviso that the α,β-unsaturated C3-C8 carboxylic acid and the α,β-unsaturated C3-C8 dicarboxylic acid are present from 4 to 26 weight percent, and with the further proviso that the total comonomer content, including the C1-C8 alkyl acrylate softening comonomer, does not exceed 50 weight percent.

Most preferably, the thermoplastic polymer according to the present invention is an ethylene/α,β-unsaturated C3-C8 carboxylic acid copolymer partially neutralized with metal ions, which is commonly referred to as “ionomer”. The total percent neutralization is from 5 to 90 percent, preferably 10 to 70 percent, most preferably between 25 and 60 percent of the ionomer.

In the case where the thermoplastic polymer is an ethylene/α,β-unsaturated C3-C8 carboxylic acid copolymer partially neutralized with metal ions, the α,β-unsaturated C3-C8 carboxylic acid can be chosen from acrylic acid and/or methacrylic acid.

The ethylene/α,β-unsaturated C3-C8 carboxylic acid copolymer partially neutralized with metal ions is preferably a terpolymer of ethylene, α,β-unsaturated C3-C8 carboxylic acid and α,β-unsaturated C3-C8 dicarboxylic acid partially neutralized with metal ions.

The α,β-unsaturated C3-C8 dicarboxylic acid can be chosen from the same components as already described above.

The ethylene/α,β-unsaturated C3-C8 carboxylic acid/α,β-unsaturated C3-C8 dicarboxylic acid polymer partially neutralized with metal ions can further comprise up to 40 weight percent of an C1-C8 alkyl acrylate softening comonomer, which is preferably chosen among the same components as already described above.

In the ethylene/α,β-unsaturated C3-C8 carboxylic acid/α,β-unsaturated C3-C8 dicarboxylic acid polymer partially neutralized with metal ions, from 5 to 90 percent of the total number of α,β-unsaturated C3-C8 carboxylic acid units in the polymer are neutralized with metal ions, and the α,β-unsaturated C3-C8 carboxylic acid and the α,β-unsaturated C3-C8 dicarboxylic acid can be present in the same amounts as described above, with the same proviso regarding the α,β-unsaturated C3-C8 carboxylic acid and the α,β-unsaturated C3-C8 dicarboxylic acid and the same further proviso regarding the total comonomer content, including the C1-C8 alkyl acrylate softening comonomer, as described above.

The ethylene/α,β-unsaturated C3-C8 carboxylic acid copolymer that are partially neutralized are partially neutralized with metal ions which can be any metal ion of group I or group II of the periodic table. In practice however, the preferred metal ions are sodium, zinc, lithium, magnesium, calcium or a mixture of any of these. More preferred are sodium, zinc, lithium and magnesium. Most preferably, the ion is zinc, lithium and/or combinations thereof.

The partially neutralized ethylene/α,β-unsaturated C3-C8 carboxylic acid copolymers according to the present invention may be prepared by standard neutralization techniques, as disclosed in U.S. Pat. No. 3,264,272.

The resulting ionomers may have an melt index (MI) of from 0.01 to 100 grams/10 minutes, preferably 0.1 to 30 grams/10 minutes, as measured using ASTM 0-1238, condition E (190° C., 2160 gram weight).

The above ionomers can be prepared by free-radical copolymerization methods, using high pressure, operating in a continuous manner known in the art such as is described in U.S. Pat. Nos. 4,351,931; 5,028,674; 5,057,593 and 5,859,137.

The successful use of the thermoplastic composition according to the present invention relies mainly on the fact that the thermoplastic polymer is dispersed in a non-continuous continuum.

In addition, the thermoplastic composition may optionally comprise reactive or non-reactive additives such as, but not limited to, colorants, diluents, processing agents, UV additives, fire retardants, mineral fillers, organic fillers, bonding additives, surfactants, aramid pulp, antioxidants, antistatic, slip agents, tackifiers, plasticisers, and/or combinations thereof as known in the art and which can be incorporated by known methods.

Fire retardants may be chosen from brominated flame retardants, red phosphorus, asbestos, antimony trioxide, borates, metal hydrates, metal hydroxides, Tetrakis(hydroxymethyl)phosphonium salts, fluorocarbons and/or combination thereof.

### Fabric

Suitable fabrics are those comprising fibrous yarns having a yarn tenacity of at least 15 g/dtex, and a tensile modulus of at least 40 g/dtex. Preferably, the yarns have a tenacity of at least 20 g/dtex, and a tensile modulus of at least 500 g/dtex. In some embodiments, the yarns have a linear density of from 220 to 3300 dtex or even from 440 to 1400 dtex. In another embodiment, the yarns have a linear density of 1100 dtex.

The ballistic resistant fabric of this invention may be a woven fabric, a knit, a unidirectional fabric, a multiaxial fabric, a nonwoven fabric, a three-dimensional (3D) fabric or a combination thereof. A woven fabric, a unidirectional fabric and a multiaxial fabric comprise yarns of continuous filaments. A multiaxial fabric may also comprise a nonwoven fabric. In the context of this invention, a nonwoven fabric is a fabric comprising randomly oriented short fibers. Examples of a nonwoven fabrics are a needled or hydroentangled felts, meltblown and/or spunbonded fabrics. Examples of woven fabrics are plain weaves, satin weaves, crowfoot weaves, rip-stop weaves, basket weaves, leno weaves and twill weaves.

A unidirectional fabric is a fabric wherein all the yarns within one layer of the fabric are aligned in one direction. A multiaxial fabric is a non-crimped fabric comprising a plurality of unidirectional fabric layers wherein the yarn orientation between successive layers is in a different direction. Common multiaxial fabrics comprise two, four or six layers. U.S. Pat. No. 6,000,055 to Citterio describes a multiaxial layer suitable for use in a ballistic resistant article.

Pluralities of adjacent unidirectional fabric layers are held together by stitching in a transverse direction through the plane of the unidirectional layers or from a polymeric bonding substrate placed between the adjacent layers. In some embodiments, a combination of both transverse yarn stitching and a polymeric bonding substrate may be used.

All the above fabric types are well known in the textile art.

The fiber material of the fabric can be chosen among aromatic polyamide fibers, such as for example, but not limited to, poly-paraphenylene terephthalamide (p-aramid) commercially available as Kevlar® from E.I. du Pont de Nemours and company, Wilmington, Del. (hereinafter DuPont), poly-metaphenylene terephthalamide (m-aramid) commercially available as Nomex® also from DuPont and, liquid crystalline polymer and ladder-like polymer fibers, for example, polybenzimidazoles or polybenzoxazoles, especially poly-para-phenylene-2,6-benzobisoxazole (PBO), 5-amino-2-(p-aminophenyl)-benzimidazole, or poly(2,6-diimidazo[4,5-b-4,5-e]pyridinylene-1,4-(2,5-dihydroxyl)phenylene) fibers, highly oriented polyolefin fibers, for example, high molecular weight polyethylene (HMPE) fibers, polypropylene fibers, ballistic nylons, high strength mineral fibers, for example, glass fibers, basalt fibers and/or combinations thereof, provided that the ballistic fabric meets the ballistic performance requirements, as known to those skilled in the art.

Preferably, the fiber material can be chosen among highly oriented polyolefin fibers, aromatic polyamide fibers, PBO fibers, or glass fibers, and/or combinations thereof. More preferably, the fiber material is poly-paraphenylene terephthalamide or poly-metaphenylene terephthalamide. A preferred aromatic polyamide is para-aramid. As used herein, the term para-aramid filaments means filaments made of para-aramid polymer. The term aramid means a polyamide wherein at least 85% of the amide (—CONH—) linkages are attached directly to two aromatic rings. Suitable aramid fibers are described in Man-Made Fibers—Science and Technology, Volume 2, in the section titled Fiber-Forming Aromatic Polyamides, page 297, W. Black et al., Interscience Publishers, 1968. Aramid fibers and their production are, also, disclosed in U.S. Pat. Nos. 3,767,756; 4,172,938; 3,869,429; 3,869,430; 3,819,587; 3,673,143; 3,354,127; and 3,094,511.

An advantage of using the thermoplastic composition according to the present invention in PPE is that the shelf life is almost unlimited for fabrics pre-impregnated with the thermoplastic polymer, in contrast to fabrics pre-impregnated with curable thermoset resins widely used in the art of ballistic protection systems, which have a limited shelf life. Fabrics pre-impregnated with curable thermoset resins slowly cure even when stored at cool temperatures, which is why they need to be processed quickly after pre-impregnation. In addition, thermoset resins heavily used in the field, such as phenolic resins, liberate VOCs (Volatile Organic Compounds) and require additional venting of the storage spaces and additional safety measures during processing.

Also, curable materials such as epoxy resins or phenolic resins are much more rigid than the thermoplastic compositions according to the present invention, which adds to the discomfort felt by the wearer. Without wishing to be held to particular theory, the non-continuous voids are acting as a softening agent by interrupting the otherwise continuous phase of thermoplastic polymer. Instead of embedding the fibers with a continuous thermoplastic polymer, the process according to the present invention will create interruptions in the otherwise homogenous composite structure. This creates a network-like phase of voids which will not therefore contact the entirety of the fiber surface, which results in unexpected benefit of increased flexibility of the reinforced fabric layer according to the present invention. Partial but continuous and uniform impregnation across the layer section will occur and surprisingly favour the flexing ability of the layers and resulting pack assemblies. The present invention further provides for a ballistic fabric that is reinforced with a thermoplastic resin, which can be particularly useful in manufacturing thermoformed personal protection equipment suited for the female anatomy.

The thickness of the thermoplastic resin layer prior to impregnation into the fabric may be chosen depending on the end-use application. The optimal thickness of the thermoplastic layer depends on the number and thickness of fabrics that must be impregnated with the thermoplastic resin. If only one side of the fabric layer(s) has to be impregnated, then the thickness of the at least one thermoplastic layer is preferably from 10 to 200 μm. If both sides of the fabric layer(s) have to be impregnated, then the thickness of each at least one thermoplastic layer should preferably be from 5 to 150 micrometers and more preferably from 15 to 100 micrometers. A primary reason for this preferred difference in thickness of the at least one thermoplastic layer is that sufficient thermoplastic resin should be available for proper impregnation of the aramid fabric layer in order to form an interpenetrating network of fibers substantially surrounded by the thermoplastic resin. In the composite the thermoplastic layer has been impregnated into the fabric layer and is no longer present in the form of a distinct layer, but rather as a thermoplastic resin continuum on the surface of and within the fabric layer.

According to the present invention, the fabric is reinforced with a thermoplastic composition.

### Protective Article

A plurality of composites of this invention can be assembled into a protective article. The article may comprise other components such as foam, metal, glass or ceramics. Preferably, the individual composites of the article according to the invention are not connected to each other in a way that restricts their movement relative to each other, but only in a way to form a stack comprising a coherent bundle of free individual composites. This can be done, for example, by stitching the assembly of composites in such a way that only a very small percentage, say less than 10% or 5%, of the surfaces of the composites are stitched together. This can be done, for example, by edge or corner stitching, these techniques being well known in the art. Alternatively, the fabric layers may be stacked on top of each other and placed into pouches or bags. Thus each individual reinforced fabric layer of the invention is able to move with respect to other fabric layers, within the plane defined by that individual reinforced fabric layer. Alternatively, the stack can be taped along the edges.

The article may be useful in different applications where protection is sought against multiple threats, such as for example knife and spike threats, but also against ballistic threats, in garments or articles such as for example, ballistic rated body armor.

Method of Making the Composite A method of making the composite comprises the steps of:
(a) providing an assembly comprising in order, a release layer, a thermoplastic resin layer, a fabric and, optionally, a second release layer,
(b) combining a plurality of assemblies of step (a) into a stack,
(c) subjecting the stack from step (b) to a thermopressing process wherein the process comprises a minimum of two cycles where each cycle comprises
   (i) thermopressing the stack for a defined period under a defined temperature and pressure, and
   (ii) releasing the pressure on the stack for a defined period of time,
(d) cooling the stack,
(e) removing the individual assemblies from the stack, and
(f) removing the release layer(s) from each assembly to leave a composite,
wherein the defined time periods, temperatures and pressures of each thermopressing cycle are such that the composite has between 80 to 95% of the void volume of the fabric filled with resin.

The composite can be made by applying the thermoplastic composition to the fabric using methods known in the art, such as, but not limited to, lamination, calendaring, heat pressing, powder impregnation, liquid impregnation, extrusion coating, and/or combinations thereof. Preferably, the reinforcement of the fabric is achieved by thermopressing with the thermoplastic composition.

The thermoplastic composition can be applied in various forms such as, but not limited to, sheets, fabrics, hotmelts, powder, liquids, and/or combinations thereof. Preferably, the thermoplastic resin is applied as a sheet having a thickness of 10 to 200 micrometers. More preferably, the thermoplastic resin is applied as a sheet having a thickness of 30 to 150 micrometers. Most preferably, the thermoplastic composition is applied as a sheet having a thickness of 40 to 100 micrometers.

The temperature at which the fabric is reinforced with the thermoplastic composition must be at least at or above the melting point of the thermoplastic polymer, with the proviso that the temperature at which the fabric is reinforced with the thermoplastic composition does not exceed a temperature that adversely affects the fabric fiber. These temperatures are, for example, at 230° C. for aramids, 140° C. for high molecular weight polyethylene (HMPE), 300° C. for PBO and 450° C. for glass fiber.

In some embodiments, the resin and release layer may be pre-combined by lamination or extrusion or they may be co-extruded.

The release layer is prepared by conventional methods such as for example blown film extrusion, cast film extrusion or cast sheet extrusion. Preferably the release layer has a melting temperature which is substantially higher than that of the thermoplastic resin layer in order for the release layer to remain physically and chemically intact during subsequent processing and to be eventually easily peeled off from the impregnated fabric layer. Preferably the melting temperature of the release layer is at least 20° C., still more preferably at least 50° C., higher than the melting temperature of the thermoplastic layer.

Examples of polymers suitable for use as a release layer include polyesters, polypropylenes, polyethylenes, polyvinyl chlorides, polystyrenes and mixtures thereof. Preferably, the material used in the release layer is a polyester such as for example polyethylene terephthalate (PET), polypropylene terephthalate (PPT), polybutylene terephthalate (PBT), polycyclohexylene dimethylene terephatalate (PCT), or polynaphthalene terephthalate (PEN), polyethylene terephthalate (PET) being preferred. The at least one release layer may further comprise various additives such as for examples slip additives, anti-bloc additives, pigments or colorants, inorganic fillers such as calcium carbonate or talcum and foaming agents. With the aim of rendering the release layer visible, it may comprise pigments or colorants.

The thickness of the release layer will depend on the thickness of the thermoplastic layer. The release layer must be thick enough so that it is capable of being peeled off from the thermoplastic layer and so that it is not mechanically damaged during the flowing process. Typically, the release layer has a thickness in the range of about 1 to about 70 micrometers and preferably in the range of about 5 to about 50 micrometers.

In the process according to WO 2010/036406, the stack undergoes heat and pressure (thermopressing), typically by using a heating press which comprises different layers of heaters in order to maintain a constant temperature during resin flow. The stack is an assembly made of at least one fabric layer and at least one multilayer structure positioned to each other in an alternate sequence with the thermoplastic layer of the multilayer structure being in physical contact with the aramid fabric layer. The preparation of the stack can be done for example by means of two machines alternatively delivering an aramid fabric layer and one or more multilayer structures. Such machines can also comprise a system for cutting such different layers to fit the size of the heating press. The different layers of the stack are simultaneously heated in a press during a time and at a pressure and temperature sufficient to insure that the thermoplastic resin flows, saturates and encapsulates the fibers of the aramid fabric layers without substantially altering the chemical and physical properties of the release layer. Typically, the stack is pressed at a pressure between 2 and 100 bars and more preferably between 10 and 40 bars. The temperature is typically at least about 30° C. beyond the melting point of the thermoplastic layer to enable proper phase transitioning of the thermoplastic resin. The thermopressing time is preferably between 20 and 60 minutes and depends on the number of different layers of the stack. The impregnated composite structure is cooled, typically to 50° C., while keeping constant the pressure and then is cooled to room temperature under ambient conditions. The final product is eventually retrieved from the stack by peeling off the release layers from the impregnated composite structure.

Preferably, the thermopressing process stage of the present inventions is carried out in a plurality of steps. The number of thermopressing steps may be two, three, four or even more. In preferred embodiments, the length of each thermopressing step is from 5 to 300 or from 10 to 300 seconds with a length of about 20 seconds being particularly useful. The duration period for each thermopressing step may be the same or different. Preferably, the thermopressing pressure is from 10 to 30 bar, more preferably from 12 to 20 bar with a pressure of about 15 bar being most preferred. The pressure at each thermopressing step may be the same or different. At least two of the thermopressing steps should be carried out at a different temperature. The temperature of the first thermopressing step should be higher than the temperature of the last thermopressing step. Preferably the temperature of the first thermopressing step is in the range of from 110 to 180 C or from 130 to 180 degrees C. and that of the last thermopressing step of from 20 to 60 or from 40 to 60 degrees C. In a process involving three thermopressing steps, the second step may be carried out in the temperature range of from 110 to 180 degrees C. In a process where there are more than two thermopressing steps, the first and second steps may be carried out at the same temperature. In a process involving four thermopressing steps, the third step may be carried out in the temperature range of from 60 to 110 degrees C. In some embodiments the second thermopressing temperature is between 80 to 120 percent of that of the first thermopressing temperature. In some embodiments the third thermopressing temperature is between 40 to 70% percent of that of the first thermopressing temperature. Between each thermopressing step, the pressure on the stack is released for a period of time, for example for between 5 and 300 seconds. A period of about 20 seconds has been found to be useful. Where there are a plurality of pressure release steps, the duration of the pressure release may be the same or different.

The processing parameters should be such that the resin impregnates the fabric to an extent that between 80 to 95% of the void volume of the fabric is filled with resin.

Surprisingly, it has been found that a process comprising a plurality of short thermopressing steps can result in a much shorter overall total thermopressing time than that possible by the single processing step as described in WO 2010/036406.

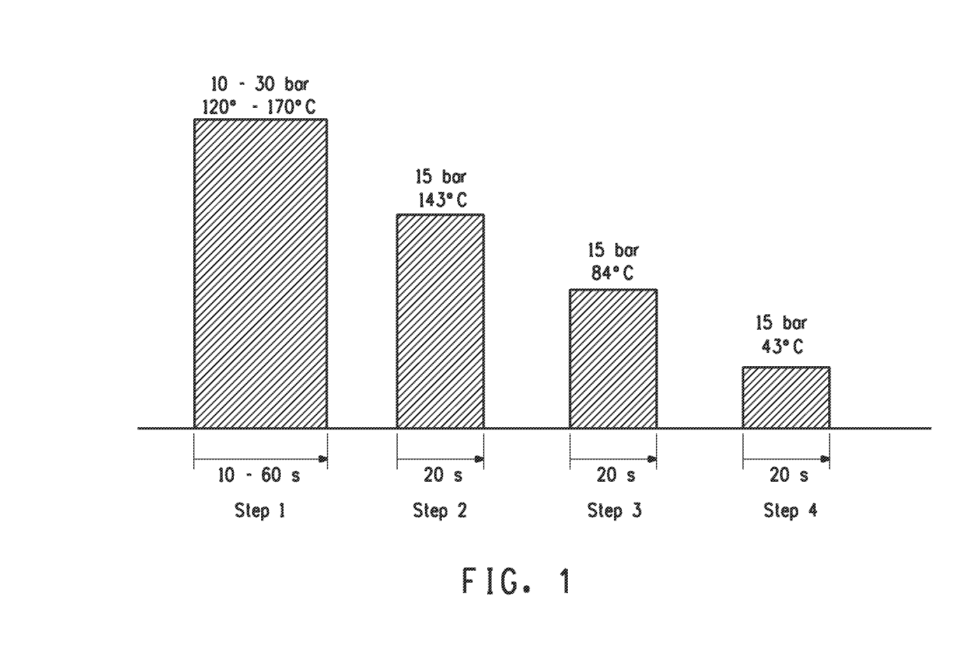

Any suitable equipment can be used to carry out the thermopressing process. Vibration and ultrasonic means can also be used as potential heat sources. Multiple presses may be used to achieve the necessary number of thermopressing steps. A processing profile for a four step process is described below and is also illustrated in FIG. 1:

(1) in a first step, the stack is thermopressed at 10 to 30 bar and at a temperature of 120° C. tO 170° C. for between 10 to 60 seconds followed by a pressure release period,

(2) in a second step, stack is thermopressed at 15 bar at a temperature of 143° C. for 20 seconds followed by a pressure release period,

(3) in a third step, the stack is thermopressed at 15 bar at a temperature of 84° C. for 20 seconds followed by a pressure release period, and

(4) in a fourth step, the stack is thermopressed at 15 bar at a temperature of 43° C. for 20 seconds followed by a pressure release period.

Although this is a preferred embodiment, the number of steps may be reduced or increased as well as the values of pressure, time and temperature.

As the number of thermopressing steps is reduced, the duration of these steps may need to be longer and the temperature higher. Conversely, if the number of thermopressing steps is increased, then the duration of each step may be shorter and the temperatures lower.

The method according to the present invention has numerous advantages and interests over that described in WO 2010/036406. Rather than processing batches of assembled layers, as in WO 2010/036406, it can be used on layers presented in a continuous form, for example from a roll. This allows an easier handling and less loss of material.

Also, it allows the use of conventional presses, for example one press with different temperature zones (to allow the realization of all desired thermopressing step in one pass) or a press with one single temperature zone but carrying our all steps one after the other (mainly with a change of temperature), or a succession of presses each carrying out one step in parallel. Pressing can occur by direct contact or can be generated indirectly or induced by non-contacting pressing effects such as fluid pressure from a liquid or gas.

### Test Methods

Bending stiffness of the composite was tested on a L&W bending tester code 160 supplied by Lorentzen and Wettre, Kista, Sweden The manufacturers prescribed test method was used.

Knife and spike resistance of an article comprising a plurality of composites of this invention was tested according to the HOSDB 07 Standard from the United Kingdom Home Office, Police Science and Development Branch (PSDB) HOSDB 07 Standards “PSDB Body Armor standards for UK Police, Part 3, Knife and Spike resistance” using a P1B test blade.

Flexural testing of the composite was tested as follows. A Zwick compression test machine was equipped with a 5 cm thick polyethylene plate having a 15 cm diameter hole. The plate was fixed with the help of holding plugs to the bottom section of the test machine in such a way that the hole was centered with the axes of the load which is also the axis of the machine. A hemispherical polyethylene punch having a diameter of 5 cm was fixed to the moving part of the traction machine. An assembly comprising thirty layers of resin impregnated composite was tested for pack flexibility. The sample dimensions were 40 cm×40 cm. The test consisted of measuring the force on the punch required to push the assembly 20 mm down through the hole.

Ballistic resistance values are reported as V50 which is a statistical measure that identifies the average velocity at which a bullet or a fragment penetrates the armor equipment in 50% of the shots, versus non penetration of the other 50%. The parameter measured is V50 at zero degrees where the degree angle refers to the obliquity of the projectile to the target. The reported values are average values for the number of shots fired for each example. V50 resistance to 9 mm full metal jacket (FMJ) Remington bullets and 44 magnum SJHP Remington projectiles was tested to STANAG 2920. Edition 2.

Areal weights were determined according to ISO 3801. Thicknesses were measured as per ISO 5084.

### EXAMPLES

The present invention is further defined in the following Examples. It should be understood that these examples are given by way of illustration only. All parts and percentages are by weight unless otherwise indicated. Examples prepared according to the process of the current invention are indicated by numerical values. Control or Comparative Examples are indicated by letters. Data and test results relating to the Comparative and Inventive Examples are shown in Table 1.

In Comparative Example A and Example 1, the fabric was a plain weave fabric comprising poly-p-phenylene terephtalamide yarns of 1100 dtex, commercially available from DuPont under the tradename Kevlar® merge 1K1533. The fabric had 8.5 ends/cm in both warp and weft directions and had an areal weight of 185 gsm.

In Comparative Example A and Example 1, the polymeric film was prepared by blown film extrusion. The film was a blue colored ionomeric composition comprising (i) a copolymer of ethylene and 19 wt-% MAA (methacrylic acid), wherein 45% of the available carboxylic acid moieties were neutralized with sodium cations, the copolymer being obtained from DuPont under the tradename Surlyn®, and (ii) 1.1 wt-% of a color masterbatch based on an EVA matrix supplied by Elian, Oyonnax, France with the reference number M197328. The extruder temperatures were set for five extruder zones of the same length, according to a temperature profile of 176° C., 199° C., 221° C., 240° C. and 259° C. The die (63 cm wide) and the connecting pipes were set at 260° C. The chill roll was set at 12° C. The line speed was 30 m/min. The extruded film was a 55 micrometer thick layer of blue colored ionomer extrusion.

### Comparative Example A

An assembly was made by manually stacking in order a silicone paper release layer, an extruded thermoplastic film layer, a fabric layer, an extruded thermoplastic film layer and a silicone paper release layer. Thirty of the assemblies were placed on top of each other to form a stack.

The stack was placed in a heating press (50 Ton press from SATIM) and thermopressed with the following cycle:

(a) heating the press at 105° C. for 21 minutes;

(b) inserting the stack;

(c) thermopressing the stack for 10 minutes at 135° C. and 10 bars;

(d) thermopressing the stack for 20 minutes at 135° C. and 20 bars;

(e) cooling the stack to 50° C. for 20 minutes under a pressure of 20 bars,

(f) retrieving each assembly from the stack, (g) cooling each assembly to room temperature and removing the silicone paper release layers from each assembly to leave a resin infused fabric composite.

The composite had an areal weight of 290 gsm and an average thickness of 265 micrometers. The volumetric mass was 1094 kg/cu·m. Bending stiffness was 471.9 mNm in the machine direction and 458.6 mNm in the cross direction.

A test pack for stab resistance testing was prepared comprising twenty five layers of composite and one closed cell foam layer. The foam layer which was positioned at the back of the test pack was 3 mm thick and had an areal weight of 100 gsm. The pack was kept at room temperature for 24 hours before being tested according to the HOSDB 07 standard. A P18 test blade was used. The witness plate was foam. Each test comprised 10 drops of a new blade at 24 joules of attacking (incident) energy. There was no penetration of the blade into the witness plate, that is to say, the blade did not pass through the test pack article. A repeat test but at 36 joules of attacking energy resulted in an average blade penetration into the witness plate of 13.8 mm.

The above test was repeated but this time an SPB test spike was used. At 24 joules of attacking energy there was no penetration of the spike into the witness plate, The force required to achieve the flexural test was 2574 N.

For ballistic resistance testing, a test pack was prepared comprising thirty layers of composite adjacent to a closed cell foam layer. The foam layer which was positioned at the back of the test pack was 3 mm thick and had an areal weight of 100 gsm. Ballistic resistance was measured on dry samples conditioned at room temperature during 24 h. The V50 resistance to 9 mm FMJ bullets was 522 m/s. The V50 resistance to 44 Mag SJHP bullets was 481 m/s.

### Example 1

An assembly was made by manually stacking in order a silicone paper release layer, an extruded thermoplastic film layer, a fabric layer, an extruded thermoplastic film layer and a silicone paper release layer as per Comparative Example A. Two of these assemblies were formed into a stack. The stack was placed in a heating press (50 Ton press from SATIM) and subjected to the following thermopressing cycle with the following cycle:

(a) heating the press at 150° C.,
(b) inserting the stack,
(c) thermopressing the stack for 20 seconds at 150° C. and 15 bars,
(d) releasing the pressure on the stack for 20 seconds by opening the press,
(e) thermopressing the stack for 20 seconds at 150° C. and 15 bars,
(f) releasing the pressure on the stack for 20 seconds by opening the press,
(g) heating the press to 84° C.,
(h) thermopressing the stack for 20 seconds at 84° C. and 15 bars,
(i) releasing the pressure on the stack for 20 seconds by opening the press,
(j) heating the press to 43° C.,
(k) thermopressing the stack for 20 seconds at 43° C.,
(l) opening the press, removing the stack from the press and removing the assemblies from the stack. Cooling the assemblies at room temperature for 10 minutes under no pressure, and
(m) removing the silicone paper release layers from each assembly to give a resin infused fabric composite.

The composite had an areal weight of 290 gsm and an average thickness of 295 micrometers. The calculated volumetric mass was 983 kg/cu·M.

Bending stiffness of the composite was 152.1 mNm in the machine direction and 154.7 mNm in the cross-direction. This represents about a three times improvement in flexibility versus the comparative example, for the same areal density and the same composition.

Blade and spike tests similar to those for Comparative Example A were carried out. The blade test showed no penetration of the witness plate for 24 joules of attacking energy and an average blade penetration of 11.3 mm into the witness plate for 36 joules of attacking energy. These results are comparable with those of Comparative Example A.

The spike test using a SPB test spike gave no penetration at 24 joules of attacking energy again showing equivalence with the comparative example.

The force required to achieve the flexural test was 1209 N.

Ballistic tests gave a V50 resistance to 9 mm FMJ bullets of 507 m/s and a V50 resistance to 44 Mag SJHP bullets of 479 m/s. These results show that the ballistic performance of an article comprising composites of this invention is almost equivalent to that of Comparative Example 1 which is a representative example of the technology disclosed in WO2011/156577. However, the superior flexibility at the same areal weight of the inventive example when compared to the comparative example is very attractive to users. The results are summarized in Table 1.

TABLE 1

| Test | Units | Comp Ex 1 | Example 1 |
|---|---|---|---|
| Composite Weight | gsm | 290 | 290 |
| Resin content (calculated) | % | 36 | 36 |
| process | | control | New |
| Volumic mass (calculated) | kg/m3 | 1094 | 983 |
| Thickness | microns | 265 | 295 |
| Bending Stiffness | mNm | 471.9 | 152.1 |
| (Machine Direction) | | | |
| Bending Stiffness (Cross Direction) | mNm | 458.6 | 154.7 |
| Average Blade Penetration P1B 36 J | mm | 13.8 | 11.3 |
| Average Spike Penetration SPB 24 J | mm | 0 | 0 |
| V50 for 9 mm projectile | m/s | 522 | 507 |
| V50 for 44 Mag bullet | m/s | 481 | 479 |
| Flexural test required force | N | 9998 | 6306 |

The results demonstrate that subjecting a stack comprising only a few layers of composite components to a series of very short thermopressing cycles gives a resulting composite of greater flexibility and permits a shorter total thermopressing time when compared to a stack comprising a significantly larger number of composite components that is subjected to a single but longer thermopressing step. The personal protection properties of an article comprising a plurality of composites made by the inventive process were deemed to be acceptable.

What is claimed is:

1. A composite comprising at least one fabric and a thermoplastic polymeric resin wherein the resin is impregnated into the fabric forming a non-continuous continuum to an extent that between 80 to 95% of the maximum volumic mass (void volume) of the fabric is filled with resin.

2. A ballistic, knife or pick resistant article comprising a plurality of the composites of claim 1.

3. A method of producing a composite comprising the steps of:
(i) providing an assembly comprising in order, a release layer, a thermoplastic resin layer, a fabric and, optionally, a second release layer,
(ii) combining a plurality of assemblies of step (a) into a stack,
(iii) Subjecting the stack from step (b) to a thermopressing process wherein the process comprises a minimum of two cycles where each cycle comprises
(iv) thermopressing the stack for a defined period under a defined temperature and pressure, and
(v) releasing the pressure on the stack for a defined period of time,
(vi) cooling the stack,
(vii) removing the individual assemblies from the stack, and
(viii) removing the release layer(s) from each assembly to leave a composite,
wherein the defined time periods, temperatures and pressures of each thermopressing cycle are such that the composite has between 80 to 95% of the maximum volumic mass (void volume) of the fabric filled with resin.
